(19) United States
(12) Patent Application Publication
(10) Pub. No.: US 2015/0127772 A1
(43) Pub. Date: May 7, 2015

(54) TRANSMISSION CONTROL APPARATUS, RECEPTION CONTROL APPARATUS, TRANSMISSION CONTROL METHOD, AND RECEPTION CONTROL METHOD

(71) Applicant: SONY CORPORATION, Minato-ku (JP)

(72) Inventors: Yasuto Masuda, Kanagawa (JP); Minoru Furukawa, Chiba (JP)

(73) Assignee: SONY CORPORATION, Minato-ku (JP)

(21) Appl. No.: 14/503,844

(22) Filed: Oct. 1, 2014

(30) Foreign Application Priority Data
Nov. 7, 2013 (JP) 2013-231211

(51) Int. Cl. H04L 29/06

(52) U.S. Cl. CPC H04L 65/60
USPC 709/217

(57) ABSTRACT

There is provided a transmission control apparatus including a transmission control unit configured to transmit image data by changing a stream to transmit the image data from the stream in which the image data is recently transmitted, in each predetermined unit of the image data indicating an image to be transmitted. When another device that transmits image data exists, the transmission control unit transmits the image data by changing a stream in synchronization with the other device.

### CROSS REFERENCE TO RELATED APPLICATIONS

This application claims the benefit of Japanese Priority Patent Application JP 2013-231211 filed Nov. 7, 2013, the entire contents of which are incorporated herein by reference.

### BACKGROUND

The present disclosure relates to a transmission control apparatus, a reception control apparatus, a transmission control method, and a reception control method.

For example, a technology has been developed which suppresses band consumption at the time of switching an image (still image or moving image) that is transmitted by multicast. An example of the technology which suppresses the band consumption is described in JP 2011-135134A.

### SUMMARY

For example, an apparatus using the technology described in JP 2011-135134A receives an image stream hierarchically coded into a plurality layers, receives only a basic layer stream among the layers of the relevant image stream immediately after channel switching, and receives an extension layer stream. Therefore, in the case of using the technology described in JP 2011-135134A, there is a probability that can suppress the increase of a reception band immediately after channel switching.

However, for example, in a case where the technology described in JP 2011-135134A is used, since the band of the basic layer is overlapped, it is not always possible to sufficiently suppress the band consumption at the time of switching a stream to transmit the image.

The present disclosure proposes a transmission control apparatus, a reception control apparatus, a transmission control method, and a reception control method, which are new and improved, capable of suppressing band consumption at the time of switching an image to be transmitted.

### Solution to Problem

According to an embodiment of the present disclosure, there is provided a transmission control apparatus including a transmission control unit configured to transmit image data by changing a stream to transmit the image data from the stream in which the image data is recently transmitted, in each predetermined unit of the image data indicating an image to be transmitted. When another device that transmits image data exists, the transmission control unit transmits the image data by changing a stream in synchronization with the other device.

According to an embodiment of the present disclosure, there is provided a reception control apparatus including a reception control unit configured to control switching of reception of pieces of image data, which is transmitted from one or more external devices, by synchronously changing a stream to transmit image data in each predetermined unit. The reception control unit controls the switching of the reception of the image data, in a manner that pre-switching image data, which is received before switching, is not received while overlapping post-switching image data, which is received after switching.

According to an embodiment of the present disclosure, there is provided a transmission control method, which is performed by a transmission control apparatus, including transmitting image data by changing a stream to transmit the image data from the stream in which the image data is recently transmitted, in each predetermined unit of the image data indicating an image to be transmitted. When another device that transmits image data exists in the transmitting step, the image data is transmitted by changing a stream in synchronization with the other device.

According to an embodiment of the present disclosure, there is provided a reception control method, which is performed by a reception control apparatus, including controlling switching of reception of pieces of image data, which is transmitted from one or more external devices, by synchronously changing a stream to transmit image data in each predetermined unit. In the controlling step, the switching of reception of image data is controlled in a manner that pre-switching image data, which is received before switching, is not received while overlapping post-switching image data, which is received after switching.

According to the present disclosure, it is possible to suppress band consumption at the time of switching an image to be transmitted.

Note that the above effects are not necessarily limited. In addition to or alternative to the above effects, one effect that is set forth in the present specification or other effect that can be grasped from the present specification may be achieved.

### BRIEF DESCRIPTION OF THE DRAWINGS

FIG. 1 is an exemplary diagram illustrating an example of a typical network configuration of a camera system;

FIG. 2 is an exemplary diagram illustrating an example of a procedure at the time of switching a stream to be transmitted by IP multicast;

FIG. 3 is an exemplary diagram illustrating an example of an operation of a reception apparatus in the procedure illustrated in FIG. 2;

FIG. 4 is an exemplary diagram illustrating an example of transmission of image data which is realized by a transmission control method according to the present embodiment;

FIG. 5 is an exemplary diagram illustrating a first example of switching of an image which is realized by a reception control method according to the present embodiment;

FIG. 6 is an exemplary diagram illustrating a second example of switching of an image which is realized by a reception control method according to the present embodiment;

FIG. 7 is an exemplary diagram illustrating a third example of switching of an image which is realized by a reception control method according to the present embodiment;

FIG. 8 is an exemplary diagram illustrating an example of a configuration of a communication system according to the present embodiment; and

FIG. 9 is an exemplary diagram illustrating an example of processing related to switching of an image in a reception control apparatus according to the present embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. Transmission control method and reception control method according to the present embodiment

2. Transmission control apparatus and reception control apparatus according to the present embodiment

3. Program according to the present embodiment

(Transmission Control Method and Reception Control Method According to the Present Embodiment)

Before describing a configuration of each of a transmission control apparatus according to the present embodiment and a reception control apparatus according to the present embodiment, a transmission control method and a reception control method according to the present embodiment will be first described. In the following, the transmission control method and the reception control method according to the present embodiment will be described in connection with an example in which the processing related to the transmission control method according to the present embodiment is performed by the transmission control apparatus according to the present embodiment and the processing related to the reception control method according to the present embodiment is performed by the reception control apparatus according to the present embodiment.

Also, in the following, a case where the transmission control apparatus according to the present embodiment has a function of transmitting image data, that is, a case where the transmission control apparatus according to the present embodiment functions as a transmission apparatus, will be mainly described. In the following, the transmission control apparatus having the function of transmitting the image data according to the present embodiment is represented by “transmission apparatus according to the present embodiment”. For example, the transmission control apparatus according to the present embodiment can control transmission of image data in an external transmission apparatus having a function of transmitting image data, regardless of the presence or absence of the function of transmitting the image data.

Also, in the following, a case where the reception control apparatus according to the present embodiment has a function of receiving image data, that is, a case where the reception control apparatus according to the present embodiment functions as a reception apparatus, will be mainly described. In the following, the reception control apparatus having the function of receiving the image data according to the present embodiment is represented by “reception apparatus according to the present embodiment”. For example, the reception control apparatus according to the present embodiment can control reception of image data in an external reception apparatus having a function of receiving image data, regardless of the presence or absence of the function of receiving the image data.

Also, in the following, the transmission control method and the reception control method according to the present embodiment will be described focusing on a case where the communication system according to the present embodiment, including the transmission control apparatus according to the present embodiment and the reception control apparatus according to the present embodiment, is applied to a camera system used in a broadcasting station or the like. Note that application examples of the communication system according to the present embodiment are not limited to the camera system used in the broadcasting station. For example, the communication system according to the present embodiment can be applied to any system that can transmit image data from one or more transmission apparatuses of a transmission side by multicast or unicast and receive the image data in an apparatus of a reception side by switching.

Example of Existing Technology Related to Switching of Image

Before describing the transmission control method and the reception control method according to the present embodiment, an example of an existing technology related to switching of an image will be described.

For example, in a case where a camera system used in a broadcasting station or the like is realized by a best-effort type internet protocol (IP), data must not be lost on a network and image quality also must not be changed. For example, a video conference system or the like uses a technique for preventing data loss on a network by dynamically changing an image encoding rate according to a congestion state of the network. However, since the camera system as described above does not permit the dynamic change of the image quality, it may be difficult to adopt the technique for preventing data loss on the network.

Also, for example, in a case where the technology described in JP 2011-135134A is used, as described above, it is not always possible to sufficiently suppress the band consumption at the time of switching the stream to transmit the image. Furthermore, for example, in a case where the technology described in JP 2011-135134A is used, the image quality is inevitably temporarily degraded.

Therefore, the camera system used in the broadcasting station or the like demands a mechanism that ensures a band necessary for transmission, without changing an image transmission rate.

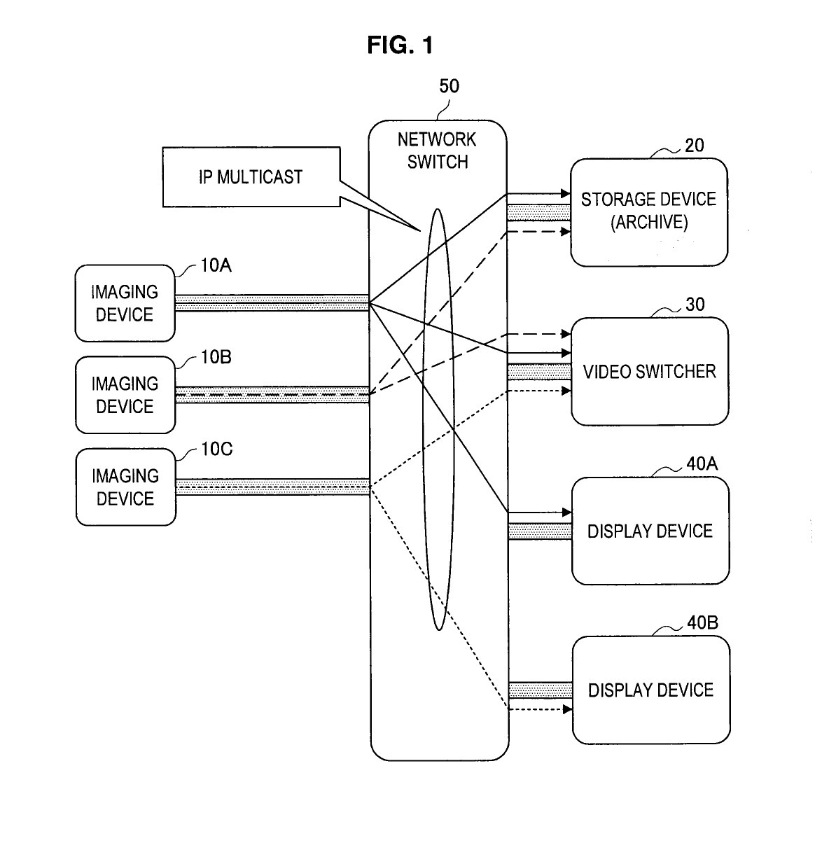

FIG. 1 is an exemplary diagram illustrating an example of a typical network configuration of a camera system. The camera system includes, for example, an imaging device 10A, an imaging device 10B, an imaging device 10C, a storage device 20, a video switcher 30, a display device 40A, a display device 40B, and a network switch 50.

In the camera system illustrated in FIG. 1, each of the imaging devices 10A to 10C serves as a transmission apparatus that transmits image data. Also, in the camera system illustrated in FIG. 1, each of the storage device 20, the video switcher 30, the display device 40A, and the display device 40B serves as a reception apparatus that receives the image data. Also, for example, in the camera system illustrated in FIG. 1, many-to-many image transmission by IP multicast is performed between the transmission apparatus and the reception apparatus through the network switch 50.

For example, in the camera system illustrated in FIG. 1, the video switcher 30, the display device 40A, the display device 40B, or the like is used while switching an image to be received.

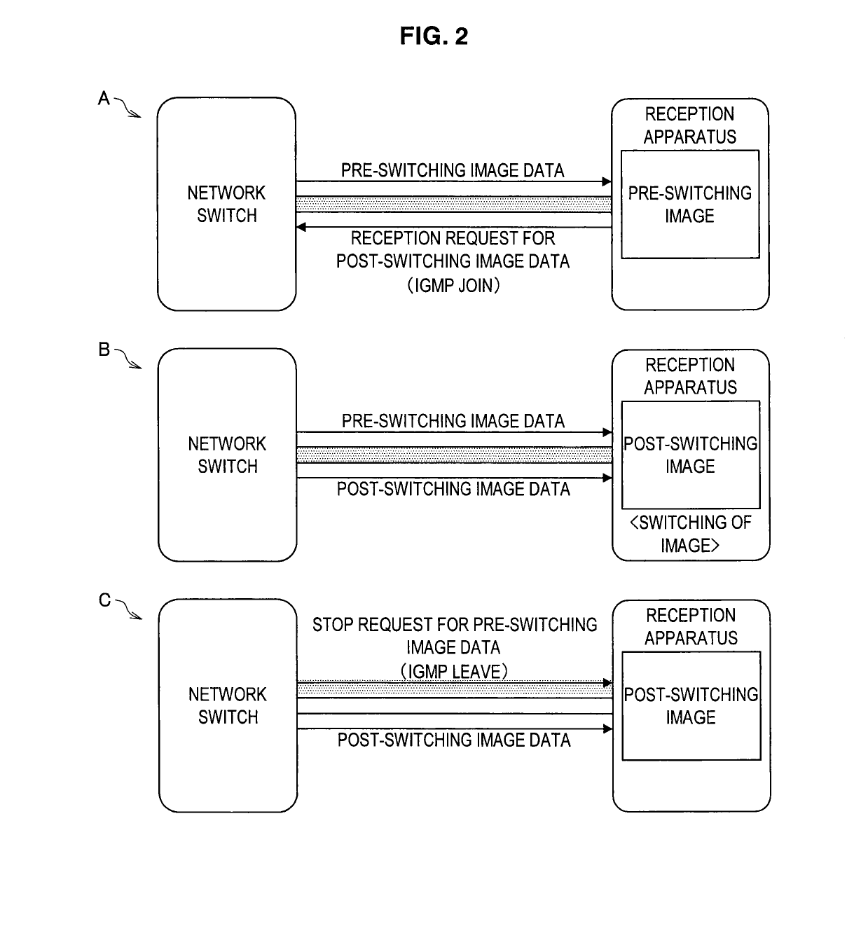

FIG. 2 is an exemplary diagram illustrating an example of a procedure at the time of switching a stream to be transmitted by IP multicast. FIG. 2 illustrates an example of a procedure that is typically performed in a case where the reception apparatus switches a stream by transmitting various requests to the network switch. A illustrated in FIG. 2 to C illustrated in FIG. 2 are illustrated in a time series in order of A illustrated in FIG. 2, B illustrated in FIGS. 2, and C illustrated in FIG. 2.

Here, the stream according to the present embodiment refers to, for example, a data flow through which a port number and a multicast address are inherently transmitted.

The reception apparatus transmits a reception request for post-switching image data (for example, “internet group management protocol (IGMP) JOIN”, hereinafter simply referred to as “JOIN”) to the network switch (A of FIG. 2). The network switch having received the reception request starts transmitting image data corresponding to the relevant reception request (image data indicating the post-switching image), and the transmitted image data is received by the reception apparatus. For example, the reception apparatus switches the image in a next field boundary of the image data from the pre-switching image to the post-switching image (B of FIG. 2). The reception apparatus transmits a reception stop request for the pre-switching image data (for example, “IGMP LEAVE”, hereinafter simply referred to as “LEAVE”) to the network switch (C of FIG. 2). The network switch having received the reception stop request stops transmitting image data corresponding to the relevant reception stop request (image data indicating the pre-switching image).

For example, in a case where the switching of the image is performed in the procedure illustrated in FIG. 2, the degradation of the image quality does not occur. However, for example, in a case where the switching of the image is performed in the procedure illustrated in FIG. 2, since there is a time zone in which the reception apparatus doubly receives the image before and after switching, the reception apparatus consumes a band twice in the relevant time zone.

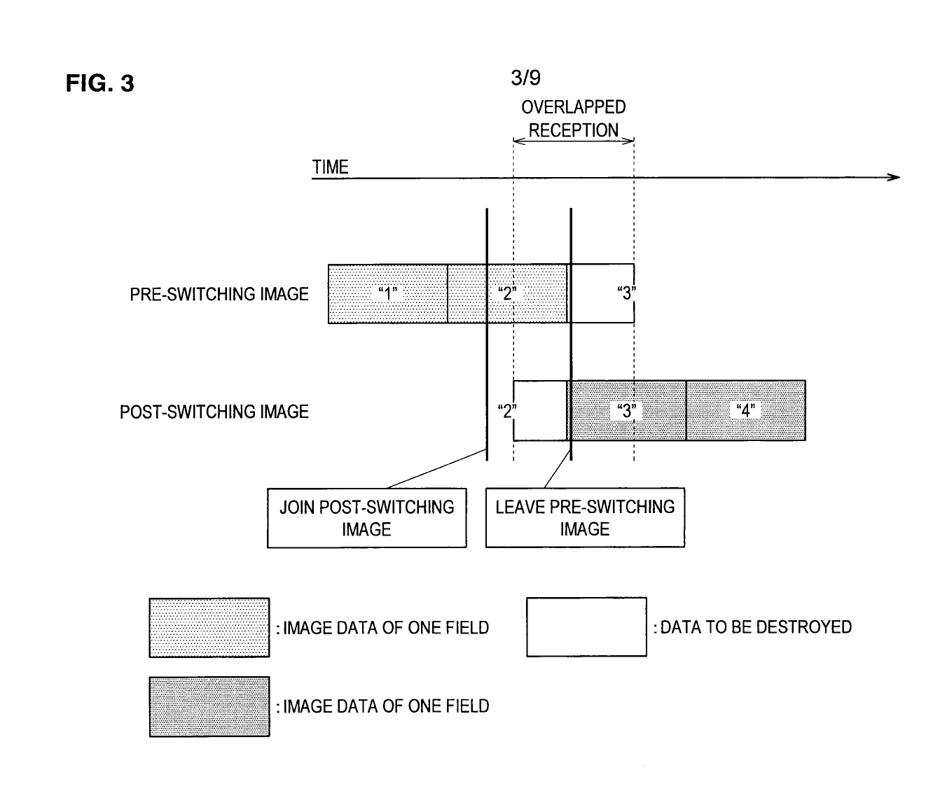

FIG. 3 is an exemplary diagram illustrating an example of the operation of the reception apparatus in the procedure illustrated in FIG. 2. FIG. 3 illustrates an example of an operation in a case where the reception apparatus receives image data that is transmitted in field unit.

When the reception apparatus transmits a reception request for post-switching image data at a timing at which a field 2 is received, the reception apparatus receives post-switching image data in the middle of the field 2 of the post-switching image. Also, for example, the reception apparatus displays the post-switching image from a field 3 being a next field boundary, and transmits a reception stop request for the pre-switching image. After the transmission of the reception stop request, for example, the transmission of the pre-switching image data is actually stopped in the network switch in the middle of a field 4.

Since it is difficult for the reception apparatus to control a timing at which the transmission of the post-switching image data is started or the transmission of the pre-switching image data is stopped, the reception apparatus has to doubly receive the post-switching image and the pre-switching image, for example, as illustrated in FIG. 3.

Therefore, for example, as illustrated in FIGS. 2 and 3, it is desirable that the band consumption at the time of switching the image to be transmitted is suppressed in the procedure in a case where the stream to be transmitted by IP multicast is switched.

Processing Related to Transmission Control Method According to the Present Embodiment

In the communication system according to the present embodiment, the transmission control apparatus according to the present embodiment transmits image data by changing the image data to a stream to be transmitted, in each predetermined unit of image data indicating an image to be transmitted (transmission control processing). The transmission control apparatus according to the present embodiment transmits image data by changing a stream to transmit the image data from the stream in which the image data is recently transmitted.

The transmission control apparatus according to the present embodiment transmits the image data by multicast, such as IP multicast. Note that the transmission control apparatus according to the present embodiment can transmit the image data by unicast. In the following, an example in which the transmission control apparatus according to the present embodiment transmits the image data by multicast will be described.

Here, an example of the predetermined unit of the image data according to the present embodiment may be field unit or frame unit. Also, the predetermined unit of the image data according to the present embodiment may be multiple field units or multiple frame units. In the following, the transmission control method and the reception control method according to the present embodiment will be described focusing on a case where the predetermined unit of the image data according to the present embodiment is one frame unit.

Also, for example, in a case where the communication system according to the present embodiment includes a plurality of transmission control apparatuses according to the present embodiment, each of the transmission control apparatuses according to the present embodiment transmits image data by changing a stream in synchronization with a transmission control apparatus according to another present embodiment (another apparatus that transmits image data).

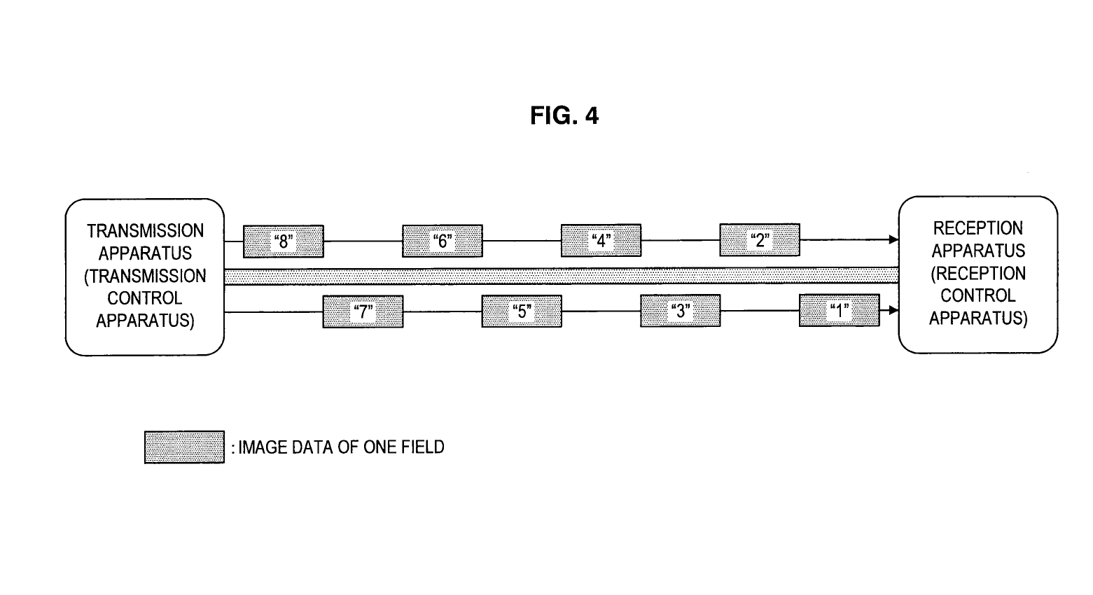

FIG. 4 is an exemplary diagram illustrating an example of transmission of image data which is realized by the transmission control method according to the present embodiment.

For example, the transmission apparatus according to the present embodiment (transmission control apparatus having the function of transmitting image data according to the present embodiment, the same applies hereinafter) transmits one image while switching the stream for each field by using two streams. For example, in a case where the image data is transmitted as illustrated in FIG. 4, the reception apparatus according to the present embodiment (reception control apparatus having the function of receiving image data according to the present embodiment, the same applies hereinafter) integrates one image into image data received by two streams and performs the display or the like of the integrated image.

For example, as illustrated in FIG. 4, the transmission control apparatus according to the present embodiment transmits image data by changing a stream from a stream in which the image data is recently transmitted, in each predetermined unit of the image data.

FIG. 4 illustrates an example in which the transmission control apparatus according to the present embodiment transmits image data by two streams, but the number of streams used for the transmission of the image data by the transmission control apparatus according to the present embodiment is not limited to the above example. The transmission control apparatus according to the present embodiment can transmit the image data by three or more streams.

Processing Related to Reception Control Method According to the Present Embodiment

The reception control apparatus according to the present embodiment controls the switching of reception of a plurality of image data, which is transmitted from one or more external devices, by performing processing related to the transmission control method according to the present embodiment in each of one or more transmission control apparatuses according to the present embodiment (reception control processing). The reception control apparatus according to the present embodiment controls the switching of reception of image data, such that pre-switching image data, which is received before switching, is not received while overlapping post-switching image data, which is received after switching.

For example, the reception control apparatus according to the present embodiment switches the reception of the image data, based on a switching request including an instruction that requests the switching of the reception. For example, the switching request according to the present embodiment is generated based on a user operation by an operation unit (which is to be described below) provided in the reception control apparatus according to the present embodiment or an external operation device. Also, the switching request according to the present embodiment may be generated based on a preset time by the reception control apparatus according to the present embodiment or the external device. Also, for example, the switching request according to the present embodiment can be generated by the reception control apparatus according to the present embodiment or the external apparatus, based on the result of the image processing in the reception control apparatus according to the present embodiment or the external device. A generation example of the switching request based on the result of image processing includes “generation of a switching request for switching to an image in which a ball is moved in an image showing a baseball game”.

More specifically, in a case where the reception of the image data is switched, when the reception of the pre-switching image data of the predetermined unit, which is transmitted by one stream, has been completed, the reception control apparatus according to the present embodiment stops the reception of the pre-switching image data by the one stream and starts the reception of the post-switching image data by the one stream.

Hereinafter, the pre-switching image is referred to as “image A” and the post-switching image is referred to as “image B”. A specific example of the switching of the image, which is realized by the reception control method according to the present embodiment, is shown taking an example of a case where the reception apparatus according to the present embodiment switches an image from an image A to an image B. The reception apparatus according to the present embodiment can switch an image from one image to another image by the processing related to the switching of the image as shown below.

(1) First Example of Switching of Image According to the Present Embodiment

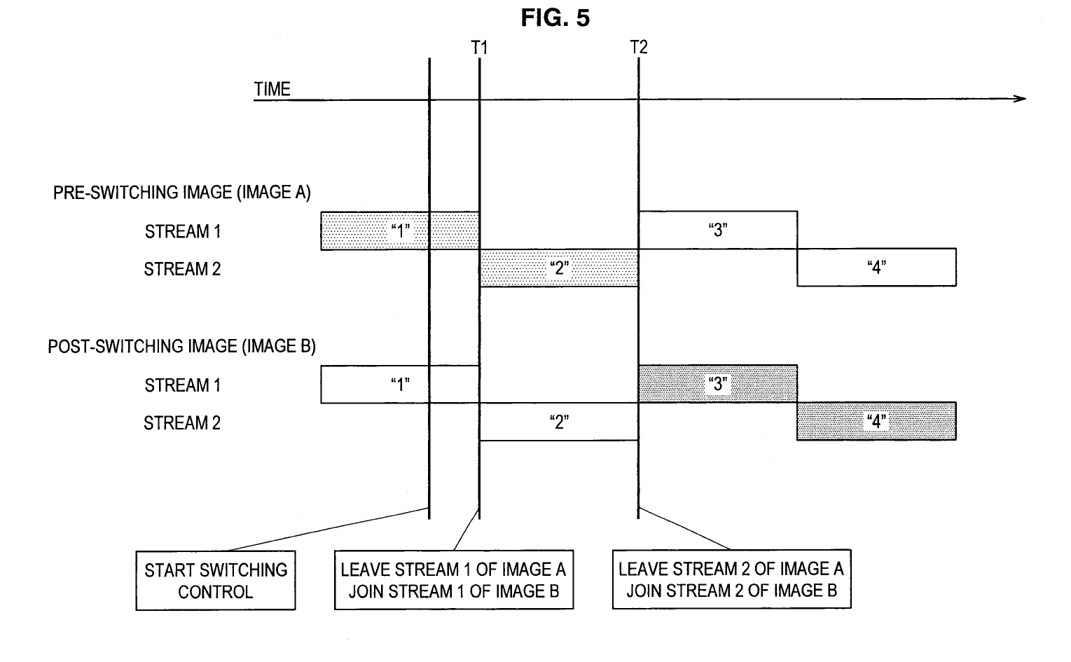

FIG. 5 is an exemplary diagram illustrating a first example of switching of image which is realized by the reception control method according to the present embodiment. FIG. 5 illustrates an example in which image data is transmitted for each field (or each frame) in two streams, that is, a stream 1 and a stream 2.

As illustrated in FIG. 5, in a case where the switching request is acquired and the stream received at a timing at which the switching control related to the reception control processing according to the present embodiment is started is the stream 1, the reception apparatus according to the present embodiment switches an image in the following procedures (a) and (b).

(a) When the stream being received is switched from the stream 1 of the image A to the stream 2 of the image A, the reception apparatus according to the present embodiment stops receiving the stream 1 of the image A and starts receiving the stream 1 of the image B (T1 illustrated in FIG. 5). For example, the reception apparatus according to the present embodiment stops receiving the stream 1 of the image A by transmitting a reception stop request to the network switch and starts receiving the stream 1 of the image B by transmitting a reception request to the network switch.

Here, the timing illustrated in T1 of FIG. 5 corresponds to a case where the reception of the image A of the predetermined unit transmitted by the stream 1 has been completed.

(b) When the stream 1 of the image B is received, the reception apparatus according to the present embodiment stops receiving the stream 2 of the image A and stops receiving the stream 2 of the image A and starts receiving the stream 2 of the image B (T2 illustrated in FIG. 5). For example, the reception apparatus according to the present embodiment stops receiving the stream 2 of the image A by transmitting a reception stop request to the network switch and starts receiving the stream 2 of the image B by transmitting a reception request to the network switch.

Here, as described above, in a case where the transmission control apparatus according to another present embodiment exists, each of the transmission control apparatuses according to the present embodiment, which constitute the communication system according to the present embodiment, transmits the image data by changing the stream in synchronization with the transmission control apparatus according to another present embodiment. That is, the timing at which the stream 1 of the image B is received and the timing at which the reception of the image A of the predetermined unit transmitted by the stream 2 has been completed are the same (or substantially the same when an error occurs due to a network delay or the like). Therefore, in other words, the timing illustrated in T2 of FIG. 5 corresponds to a case where the reception of the image A of the predetermined unit transmitted by the stream 2 has been completed.

For example, by taking the procedures illustrated in the above (a) and (b), the reception apparatus according to the present embodiment can switch the image without receiving any images of the overlapped timings.

(2) Second Example of Switching of Image According to the Present Embodiment

The first example of the switching of the image according to the present embodiment illustrated in FIG. 5 shows an example in which the predetermined unit of the image data according to the present embodiment is one field (or one frame). However, as described above, the predetermined unit of the image data according to the present embodiment is not limited to one field (or one frame) but may be multiple fields (or multiple frames).

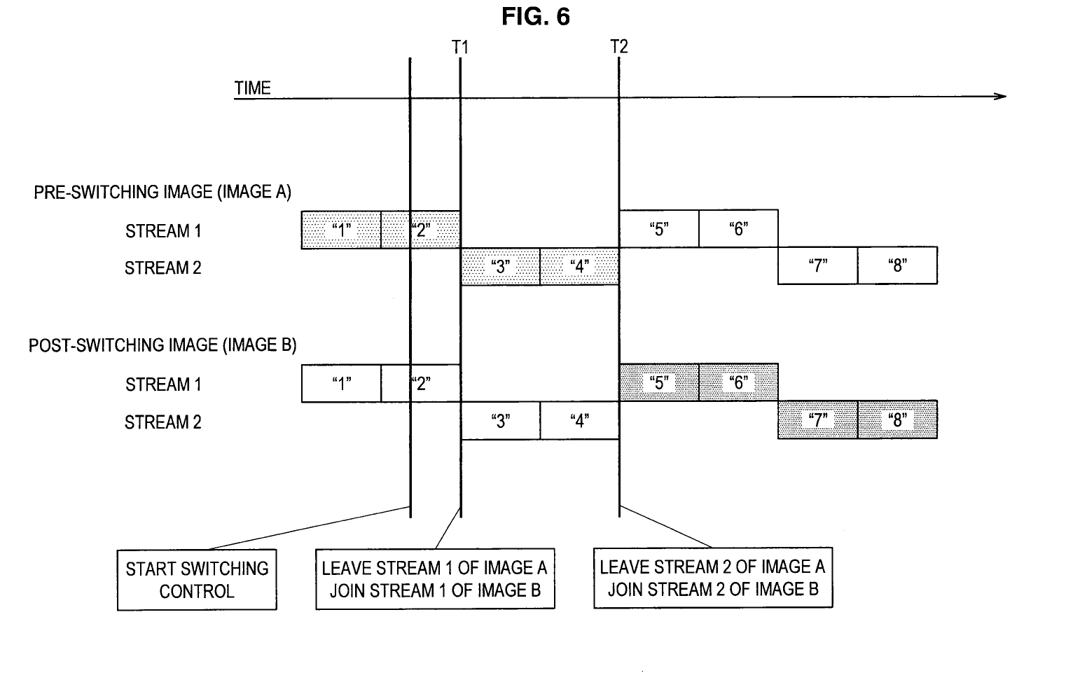

FIG. 6 is an exemplary diagram illustrating a second example of switching of image which is realized by the reception control method according to the present embodiment. FIG. 6 illustrates an example in which image data is transmitted for two fields (or two frames) in two streams, that is, a stream 1 and a stream 2.

In the second example of the switching of the image illustrated in FIG. 6, the reception apparatus according to the present embodiment also switches the image by taking the procedures illustrated in (a) and (b), as in the first example of the switching of the image illustrated in FIG. 5. Therefore, even in the second example of the switching of the image illustrated in FIG. 6, the reception apparatus according to the present embodiment can switch the image without receiving any images of the overlapped timings.

Also, in the second example of the switching of the image illustrated in FIG. 6, since the predetermined unit of the image data according to the present embodiment is two fields (or two frames), the timing of the switching of the image is later than the timing of the switching of the image by the first example of the switching of the image illustrated in FIG. 5. However, in the second example of the switching of the image illustrated in FIG. 6, for example, the network switch can have a more sufficient response time according to the reception request or the reception stop request transmitted by the reception apparatus according to the present embodiment, as compared with the first example of the switching of the image illustrated in FIG. 5. Therefore, the second example of the switching of the image illustrated in FIG. 6, for example, can ensure “the reception apparatus according to the present embodiment makes a time from the output of the reception request to the reception of the image and a time from the output of the reception stop request to the stop of the image shorter than a time when the stream is changed”, as compared with the first example of the switching of the image illustrated in FIG. 5.

(3) Third Example of Switching of Image According to the Present Embodiment

The first example of the switching of the image according to the present embodiment illustrated in FIG. 5 and the second example of the switching of the image according to the present embodiment illustrated in FIG. 6 show an example in which the image data is transmitted by two streams. However, as described above, the transmission control apparatus according to the present embodiment can transmit the image data by three or more streams.

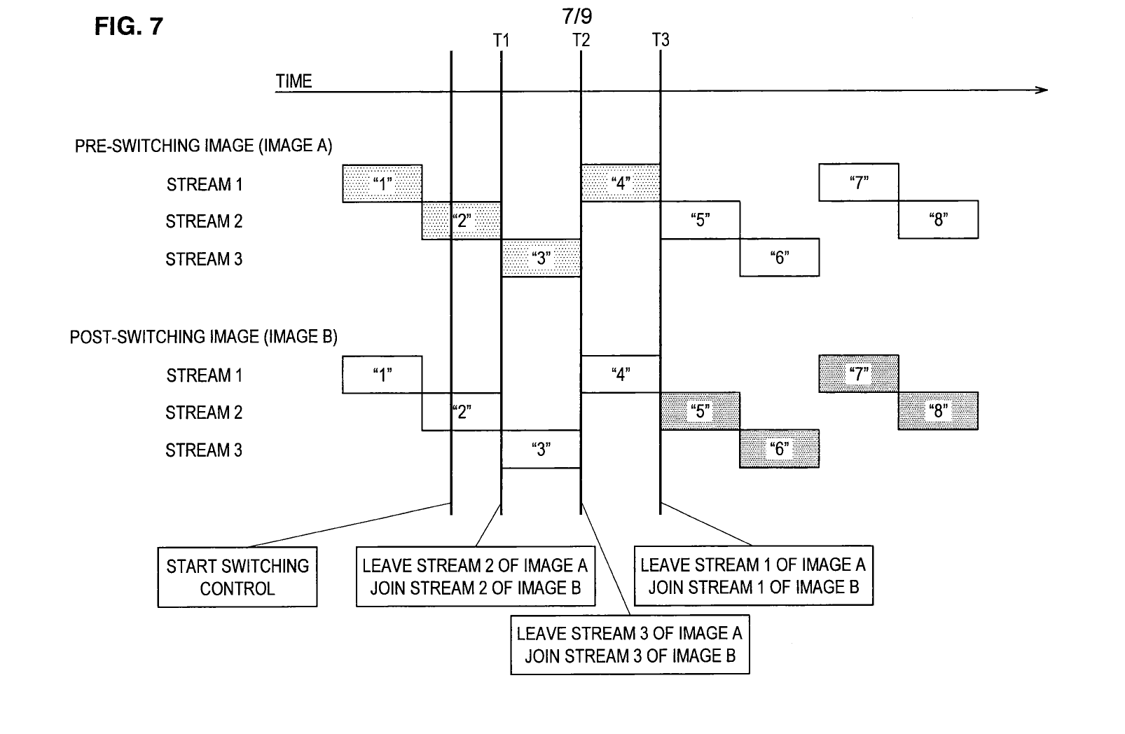

FIG. 7 is an exemplary diagram illustrating a third example of switching of image which is realized by the reception control method according to the present embodiment. FIG. 7 illustrates an example in which image data is transmitted for each field (or each frame) in three streams, that is, a stream 1, a stream 2 and a stream 3.

As illustrated in FIG. 7, in a case where the switching request is acquired and the stream received at a timing at which the switching control related to the reception control processing according to the present embodiment is started is the stream 2, the reception apparatus according to the present embodiment switches an image in the following procedures (c), (d) and (e).

(c) When the stream being received is switched from the stream 2 of the image A to the stream 3 of the image A, the reception apparatus according to the present embodiment stops receiving the stream 2 of the image A and starts receiving the stream 2 of the image B (T1 illustrated in FIG. 7). For example, the reception apparatus according to the present embodiment stops receiving the stream 1 of the image A by transmitting a reception stop request to the network switch and starts receiving the stream 1 of the image B by transmitting a reception request to the network switch.

Here, the timing illustrated in T1 of FIG. 7 corresponds to a case where the reception of the image A of the predetermined unit transmitted by the stream 2 has been completed.

(d) When the stream being received is switched from the stream 3 of the image A to the stream 1 of the image A, the reception apparatus according to the present embodiment stops receiving the stream 3 of the image A and starts receiving the stream 3 of the image B (T2 illustrated in FIG. 7). For example, the reception apparatus according to the present embodiment stops receiving the stream 3 of the image A by transmitting a reception stop request to the network switch and starts receiving the stream 3 of the image B by transmitting a reception request to the network switch.

Here, the timing illustrated in T2 of FIG. 7 corresponds to a case where the reception of the image A of the predetermined unit transmitted by the stream 3 has been completed.

(e) When the stream 2 of the image B is received, the reception apparatus according to the present embodiment stops receiving the stream 1 of the image A and stops receiving the stream 1 of the image A and starts receiving the stream 1 of the image B (T3 illustrated in FIG. 7). For example, the reception apparatus according to the present embodiment stops receiving the stream 1 of the image A by transmitting a reception stop request to the network switch and starts receiving the stream 1 of the image B by transmitting a reception request to the network switch.

Here, as described above, in a case where the transmission control apparatus according to another present embodiment exists, each of the transmission control apparatuses according to the present embodiment, which constitute the communication system according to the present embodiment, transmits the image data by changing the stream in synchronization with the transmission control apparatus according to another present embodiment. That is, the timing at which the stream 2 of the image B is received and the timing at which the reception of the image A of the predetermined unit transmitted by the stream 1 has been completed are the same (or substantially the same). Therefore, in other words, the timing illustrated in T3 of FIG. 7 corresponds to a case where the reception of the image A of the predetermined unit transmitted by the stream 1 has been completed.

For example, by taking the procedures illustrated in the above (c), (d) and (e), the reception apparatus according to the present embodiment can switch the image without receiving any images of the overlapped timings.

Also, in the third example of the switching of the image illustrated in FIG. 7, since the number of streams is one larger than the number of streams of the image by the first example of the switching of the image illustrated in FIG. 5, the network switch can have a more sufficient response time according to the reception request or the reception stop request transmitted by the reception apparatus according to the present embodiment, as compared with the first example of the switching of the image illustrated in FIG. 5. Therefore, the third example of the switching of the image illustrated in FIG. 7, for example, can ensure “the reception apparatus according to the present embodiment makes a time from the output of the reception request to the reception of the image and a time from the output of the reception stop request to the stop of the image shorter than a time when the stream is changed”, as compared with the first example of the switching of the image illustrated in FIG. 5.

Also, in the third embodiment of the switching of the image illustrated in FIG. 7, since the predetermined unit of the image data according to the present embodiment is one field (or one frame), it is possible to speed up the timing of the switching of the image as compared with the second example of the switching of the image illustrated in FIG. 6.

As a specific example of the switching of the image which is realized by the reception control method according to the present embodiment, there are examples illustrated in FIGS. 5 to 7. It is apparent that the specific example of the switching of the image which is realized by the reception control method according to the present embodiment is not limited to the examples illustrated in FIGS. 5 to 7.

In the communication system according to the present embodiment, the above-described processing related to the transmission control method according to the present embodiment is performed by the transmission control apparatus according to the present embodiment, and the above-described processing related to the reception control method according to the present embodiment is performed by the reception control apparatus according to the present embodiment.

For example, as illustrated in FIG. 4, the transmission control apparatus according to the present embodiment transmits image data by changing a stream from a stream in which the image data is recently transmitted, in each predetermined unit of the image data.

The reception control apparatus according to the present embodiment controls the switching of reception of a plurality of image data, which is transmitted from one or more external devices, by performing processing related to the transmission control method according to the present embodiment in each of one or more transmission control apparatuses according to the present embodiment. Then, as shown in FIG. 5 through FIG. 7, the reception control apparatus according to the present embodiment controls the switching of reception of image data, such that pre-switching image data, which is received before switching, is not received while overlapping post-switching image data, which is received after switching.

Therefore, there is provided the communication system that can suppress the band consumption at the time of switching the image to be transmitted by including the transmission control apparatus according to the present embodiment, which performs the processing related to the transmission control method according to the present embodiment, and the reception control apparatus according to the present embodiment, which performs the processing related to the reception control method according to the present embodiment.

Also, in a case where the transmission control apparatus according to the present embodiment performs the processing related to the transmission control method according to the present embodiment and the reception control apparatus according to the present embodiment performs the processing related to the reception control method according to the present embodiment, there is no influence on the image quality of the image data to be transmitted. Therefore, the communication system according to the present embodiment prevents the degradation of the image quality in such a manner that the transmission control apparatus according to the present embodiment performs the processing related to the transmission control method according to the present embodiment and the reception control apparatus according to the present embodiment performs the processing related to the reception control method according to the present embodiment.

Also, for example, the communication system according to the present embodiment is applied to a camera system that outputs images captured by a plurality of imaging devices while performing switching by a switcher such as the network switch, and the following effects can be obtained in a case where the communication is realized by an asynchronous communication network based on the IP or IEEE 802.3 standard.
In the switching timing of the image, image quality is not degraded and unnecessary band is not consumed.
In an image creation environment in which the image quality and the response of the switching operation are strict, the number of images that can be received by the reception apparatus can be increased twice.

(Transmission Control Apparatus and Reception Control Apparatus According to the Present Embodiment)

Next, an example of a configuration of the transmission control apparatus according to the present embodiment, which can perform the processing related to the transmission control method according to the present embodiment, and an example of a configuration of the reception control apparatus according to the present embodiment, which can perform the processing related to the reception control method according to the present embodiment will be described.

Also, in the following, an example of the configuration of the transmission control apparatus according to the present embodiment will be described taking an example of a case where the transmission control apparatus according to the present embodiment is the transmission apparatus having the function of transmitting image data according to the present embodiment. Also, in the following, an example of a configuration of the reception control apparatus according to the present embodiment will be described taking an example of a case where the reception control apparatus according to the present embodiment is the reception apparatus having the function of receiving image data according to the present embodiment.

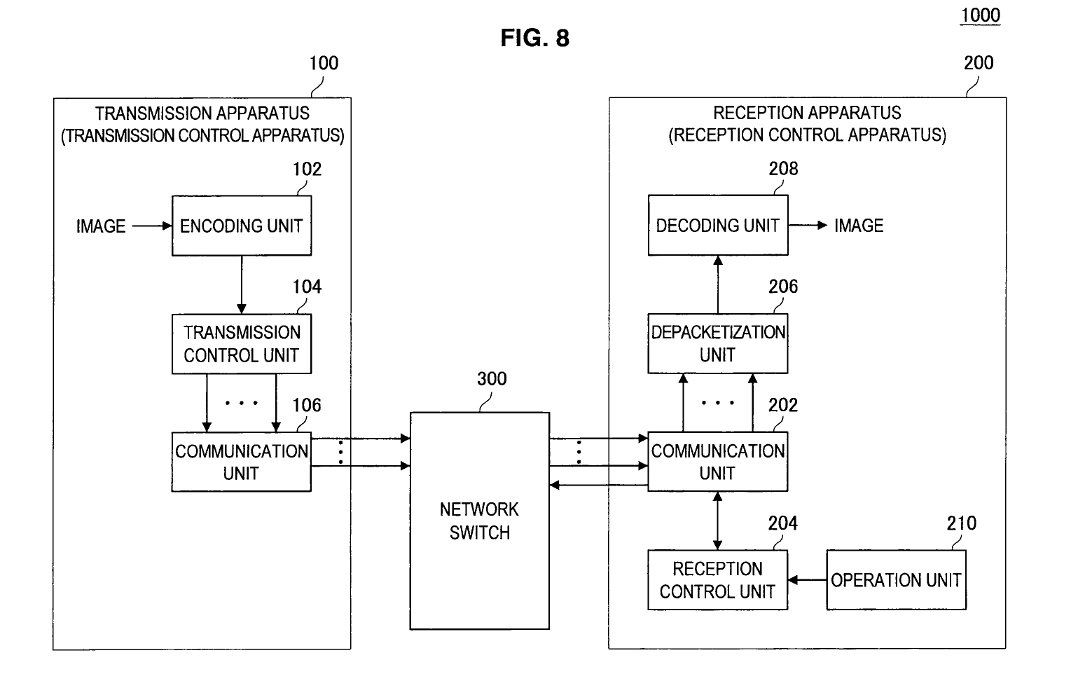

FIG. 8 is an exemplary diagram illustrating an example of a configuration of a communication system 1000 according to the present embodiment. For example, the communication system 1000 includes a transmission apparatus 100 (example of the transmission control apparatus according to the present embodiment), a reception apparatus 200 (example of the reception control apparatus according to the present embodiment), and a network switch 300. For example, the network switch 300 is configured by a switching element or a processing circuit for realizing a line or packet exchange function, and performs the line or packet exchange (switching).

Note that the configuration of the communication system according to the present embodiment is not limited to the example illustrated in FIG. 8. For example, the transmission apparatus 100 and the network switch 300 illustrated in FIG. 8 may be an integrated apparatus. That is, the transmission control apparatus according to the present embodiment can have the function of the network switch.

[1] Transmission Apparatus 100

For example, the transmission apparatus 100 includes an encoding unit 102, a transmission control unit 104, and a communication unit 106.

Also, for example, the transmission apparatus 100 may include a control unit (not illustrated), a read only memory (ROM) (not illustrate), a random access memory (RAM) (not illustrated), a storage unit (not illustrated), an operation unit (not illustrated) that can be operated by a user, a display unit (not illustrated) that displays various images on a display screen, and an imaging unit (not illustrated) that generates an captured image by capture. For example, the transmission apparatus 100 connects the respective elements by a bus as a data transmission path.

Here, for example, the control unit (not illustrated) includes a processor configured by various operation circuits, such as a micro processing unit (MPU), or various processing circuits, and controls the transmission apparatus 100 as a whole. Also, for example, the control unit (not illustrated) may serve as the encoding unit 102 or the transmission control unit 104. It is apparent that the encoding unit 102 or the transmission control unit 104 may be configured by one or more processing circuits separate from the control unit (not illustrated).

The ROM (not illustrated) stores programs or control data such as operation parameters, which are used by the control unit (not illustrated). The RAM (not illustrated) temporarily stores programs that are executed by the control unit (not illustrated) or the like.

The storage unit (not illustrated) is a storage device provided in the transmission apparatus 100 and stores, for example, various data such as image data or applications. Examples of the storage unit (not illustrated) may include a magnetic recording medium such as a hard disk, or a nonvolatile memory such as a flash memory. Also, the storage unit (not illustrated) may be detachable from the transmission apparatus 100.

Examples of the operation unit (not illustrated) may include a button, a direction key, a rotation-type selector such as a jog dial, or a combination thereof. Also, examples of the display unit (not illustrated) may include a liquid crystal display or an organic electro-luminescence display (organic EL display) (also called an organic light emitting diode display (OLED display)).

Examples of the imaging unit (not illustrated) may include a lens/imaging element and a signal processing circuit. The lens/imaging element includes a lens of an optical system, and an image sensor using a plurality of imaging elements such as complementary metal oxide semiconductor (CMOS). For example, the signal processing circuit includes an automatic gain control (AGC) circuit or an analog to digital converter (ADC), and converts an analog signal generated by the imaging element into a digital signal (image data). Also, for example, the signal processing circuit may perform a variety of signal processing, such as white balance correction processing, color tone correction processing, gamma correction processing, YCbCr conversion processing, and edge enhancement processing.

The encoding unit 102 performs encoding, such as compression or redundancy, on the image to be processed. Examples of the image to be processed by the encoding unit 102 may include image data stored in the storage unit (not illustrated) or an external recording medium, signals or data indicating captured images generated by the imaging unit (not illustrated) or an external imaging device.

The transmission control unit 104 plays a leading role in the processing related to the transmission control method according to the present embodiment. For example, the transmission control unit 104 performs transmission control processing according to the present embodiment and transmits image data by changing a stream from a stream in which the image data is recently transmitted, in each predetermined unit of the image data.

More specifically, for example, the transmission control unit 104 transmits image data, such as image data encoded by the encoding unit 102, image data encoded by the external device, image data that is not encoded, by IP packetization as a plurality of streams. Also, for example, the transmission control unit 104 transmits the image data to the communication unit 106 or the external communication device by performing the transmission control processing according to the present embodiment.

The communication unit 106 is a communication device provided in the transmission apparatus 100 and transmits the image data by the relevant stream in each predetermined unit. For example, the transmission of the image data in the communication unit 106 is controlled by the transmission control unit 104.

Examples of the communication unit 106 may include a local area network (LAN) terminal and transmission/reception circuit (wired communication), or an IEEE 802.11 port and transmission/reception circuit (wireless communication). Also, the communication unit 106 may be a communication device corresponding to a network. Examples of the network according to the present embodiment may include a wired network such as an LAN or a wide area network (WAN), a wireless network such as a wireless local area network (WLAN) or a wireless wide area network (WWAN) through a base station, and Internet using a communication protocol such as a transmission control protocol/internet protocol (TCP/IP).

For example, the transmission apparatus 100 performs the processing related to the transmission control method according to the present embodiment by the configuration illustrated in FIG. 8.

Note that the configuration of the transmission control apparatus according to the present embodiment, which can perform the processing related to the transmission control method according to the present embodiment, is not limited to the configuration of the transmission apparatus 100 illustrated in FIG. 8.

For example, the transmission control apparatus according to the present embodiment may not include the encoding unit 102 illustrated in FIG. 8 and/or the communication unit 106 illustrated in FIG. 8. Even in the configuration that does not include the encoding unit 102, the transmission control apparatus according to the present embodiment can perform the processing related to the transmission control method according to the present embodiment. Even in the configuration that does not include the communication unit 106, the transmission control apparatus according to the present embodiment can perform the processing related to the transmission control method according to the present embodiment by controlling the external communication device. Therefore, even in the configuration that the transmission control apparatus according to the present embodiment does not include the encoding unit 102 illustrated in FIG. 8 and/or the communication unit 106 illustrated in FIG. 8, it is possible to realize the communication system that can suppress the band consumption at the time of switching the image to be transmitted.

For example, since the transmission control apparatus according to the present embodiment has the line or packet exchange function (switching function), the transmission control apparatus can serve as the network switch.

[II] Reception Apparatus 200

The reception apparatus 200 includes, for example, a communication unit 202, a reception control unit 204, a depacketization unit 206, a decoding unit 208, and an operation unit 210.

Also, for example, the reception apparatus 200 may include a control unit (not illustrated), a ROM (not illustrate), a RAM (not illustrated), a storage unit (not illustrated), and a display unit (not illustrated) that displays various images on a display screen. For example, the reception apparatus 200 connects the respective elements by a bus as a data transmission path.

Here, for example, the control unit (not illustrated) includes a processor configured by various operation circuits, such as an MPU, or various processing circuits, and controls the reception apparatus 200 as a whole. Also, for example, the control unit (not illustrated) may serve as the reception control unit 204, the depacketization unit 206, or the decoding unit 208. It is apparent that the reception control unit 204, the depacketization unit 206, or the decoding unit 208 may be configured by one or more processing circuits separate from the control unit (not illustrated).

The ROM (not illustrated) stores programs or control data such as operation parameters, which are used by the control unit (not illustrated). The RAM (not illustrated) temporarily stores programs that are executed by the control unit (not illustrated) or the like.

The storage unit (not illustrated) is a storage device provided in the reception apparatus 200 and stores, for example, various data such as image data or applications. Examples of the storage unit (not illustrated) may include a magnetic recording medium such as a hard disk, or a nonvolatile memory such as a flash memory. Also, the storage unit (not illustrated) may be detachable from the reception apparatus 200.

Examples of the display unit (not illustrated) may include a liquid crystal display or an organic EL display.

The communication unit 202 is a communication device provided in the reception apparatus 200 and transmits, for example, the image data. For example, the reception of the image data in the communication unit 202 is controlled by the reception control unit 204.

Examples of the communication unit 202 may include a LAN terminal and transmission/reception circuit (wired communication), or an IEEE 802.11 port and transmission/reception circuit (wireless communication). Also, the communication unit 106 may be a communication device corresponding to a network.

The reception control unit 204 plays a leading role in the processing related to the reception control method according to the present embodiment. For example, the reception control unit 204 performs the reception control processing according to the present embodiment and controls the switching of reception of a plurality of image data, which is transmitted from one or more external devices, by performing the processing related to the transmission control method according to the present embodiment in each of one or more transmission control apparatuses according to the present embodiment, such as the transmission apparatus 100.

More specifically, for example, as illustrated in FIGS. 5 to 7, the reception control unit 204 controls the switching of reception of image data, such that pre-switching image data, which is received before switching, is not received while overlapping post-switching image data, which is received after switching. For example, the reception control unit 204 transmits various requests related to the switching of the image, such as the reception request or the reception stop request, to the network switch 300 through the communication unit 202.

For example, the depacketization unit 206 restores one image stream (one image data) by depacketizing the IP packet.

The decoding unit 208 decodes the compressed or redundant image data. For example, the image data decoded by the decoding unit 208 is stored in the storage unit (not illustrated) or the recording medium. Also, for example, the image data decoded by the decoding unit 208 is displayed on the display screen of the display unit (not illustrated) or the display screen of the external display device.

The operation unit 210 is an operation device provided in the reception apparatus 200 and generates various requests (instructions) according to user operation. Examples of the request generated by the operation unit 210 may include a switching request or a request for a desired operation of the reception apparatus 200.

Examples of the operation unit 210 may include a button, a direction key, a rotation-type selector such as a jog dial, or a combination thereof.

Next, an example of the processing related to the switching of the image in the reception control apparatus according to the present embodiment will be describes taking an example of a case where the processing related to the switching of the image is performed in the reception apparatus 200 illustrated in FIG. 8.

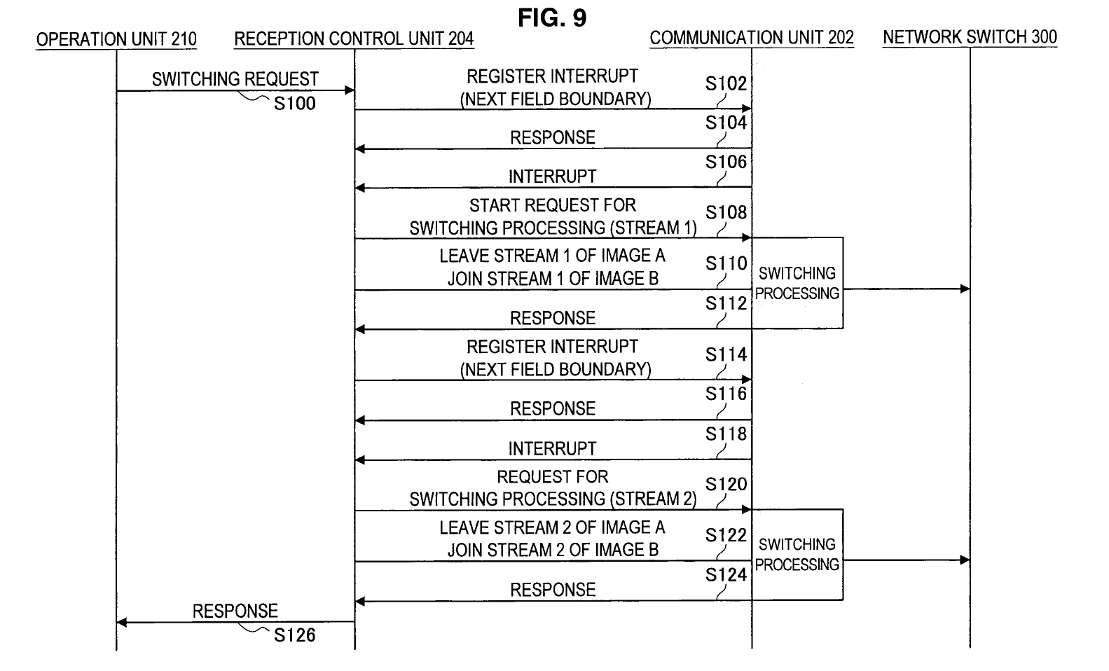

FIG. 9 is an exemplary diagram illustrating an example of the processing related to the switching of the image in the reception control apparatus according to the present embodiment. FIG. 9 illustrates an example of the processing related to the switching of the image according to the first example of the switching of the image illustrated in FIG. 5. Also, FIG. 9 illustrates an example of the processing related to the switching of the image in the reception apparatus 200 illustrated in FIG. 8.

For example, when the switching request is transmitted from the operation unit 210 (S100), the reception control unit 204 requests the communication unit 202 to perform interrupt when an image being received arrives at a filed boundary (S102). The communication unit 202 having received the request in step S102 responds to the reception control unit 204 (S104).

When the image being received arrives at the field boundary, the communication unit 202 interrupts the reception control unit 204 (S106). When the interrupt is performed, the reception control unit 204 transmits a switching request for switching the image of the stream 1 to the communication unit 202 (S108). Also, for example, the reception control unit 204 transmits various requests to the communication unit 202 with respect to the network switch 300 by transmitting the reception stop request for the stream 1 of the image A and the reception request for the stream 1 of the image B at the same time as the processing of step S108 (S110). The communication unit 202 performs a response corresponding to steps S108 and S110 with respect to the reception control unit 204 (S112). The processing related to the switching of the image of the stream 1 is completed by the processing of steps S102 to S112.

In a case where the response transmitted from the communication unit 202 in step S112 is received, that is, a case where the processing related to the switching of the image of the stream 1 is completed, the reception control unit 204 requests the communication unit 202 to perform interrupt when the image being received arrives at the field boundary (S114). The communication unit 202 having received the request in step S114 responds to the reception control unit 204 (S116).

When the image being received arrives at the field boundary, the communication unit 202 interrupts the reception control unit 204 (S118). When the interrupt is performed, the reception control unit 204 transmits a switching request for switching the image of the stream 2 to the communication unit 202 (S120). Also, for example, the reception control unit 204 transmits various requests to the communication unit 202 with respect to the network switch 300 by transmitting the reception stop request for the stream 2 of the image A and the reception request for the stream 2 of the image B at the same time as the processing of step S120 (S122). The communication unit 202 performs a response corresponding to steps S120 and S122 with respect to the reception control unit 204 (S124). The processing related to the switching of the image of the stream 2 is completed by the processing of steps S114 to S124.

When the switching of the images of the stream 1 and the stream 2 is completed, the reception control unit 204 responds to the operation unit 210 having transmitted the switching request (S126).

Here, for example, the operation unit 210, to which the response corresponding to the switching request (response illustrated in step S126) is transmitted from the reception control unit 204, may feed the effect of the switching of the image back to the user, based on the response corresponding to the relevant switching request. Examples of the processing related to the feedback to the user, which is performed by the operation unit 210, may include processing related to a visual feedback to display a text or an image on a display device, processing related to an audible feedback to output a sound or like (including music) to a sound output device, and processing related to a haptic feedback to vibrate a vibrator or the like. The processing related to the feedback to the user according to the present embodiment may be performed by other element in the reception apparatus 200, such as the reception control unit 204 or the control unit (not illustrated).

The reception control apparatus according to the present embodiment performs, for example, the processing related to the switching of the image as illustrated in FIG. 9. It is apparent that the processing related to the switching of the image in the reception control apparatus according to the present embodiment is not limited to the example illustrated in FIG. 9.

For example, the reception apparatus 200 performs the processing related to the reception control method according to the present embodiment by the configuration illustrated in FIG. 8.

Note that the configuration of the reception control apparatus according to the present embodiment, which can perform the processing related to the reception control method according to the present embodiment, is not limited to the configuration of the reception apparatus 200 illustrated in FIG. 8.

For example, the reception control apparatus according to the present embodiment may not include the operation unit 210 illustrated in FIG. 8. Even in the configuration that does not include the operation unit 210, the reception control apparatus according to the present embodiment can perform the processing related to the reception control method according to the present embodiment in response to the switching request generated by the external operation device, the switching request generated based on a preset time, and the switching request based on the result of the image processing. Therefore, even in the configuration that the reception control apparatus according to the present embodiment does not include the operation unit 210 illustrated in FIG. 8, the reception control apparatus according to the present embodiment can suppress the band consumption at the time of switching the image to be transmitted.

For example, the reception control apparatus according to the present embodiment may not include the communication unit 202 illustrated in FIG. 8. Even in the configuration that does not include the communication unit 202, the reception control apparatus according to the present embodiment can perform the processing related to the reception control method according to the present embodiment by controlling the external communication device. Therefore, even in the configuration that does not include the communication unit 202, the reception control apparatus according to the present embodiment can suppress the band consumption at the time of switching the image to be transmitted.

Also, for example, the reception control apparatus according to the present embodiment may not include the depacketization unit 206 illustrated in FIG. 8 and/or the decoding unit 208 illustrated in FIG. 8. Even in the configuration that does not include the depacketization unit 206 and/or the decoding unit 208, the reception control apparatus according to the present embodiment can perform the processing related to the transmission control method according to the present embodiment. Therefore, even in the configuration that the reception control apparatus according to the present embodiment does not include the depacketization unit 206 illustrated in FIG. 8 and/or the decoding unit 208 illustrated in FIG. 8, the reception control apparatus according to the present embodiment can suppress the band consumption at the time of switching the image to be transmitted.

The transmission control apparatus has been described above as the present embodiment, but the present embodiment is not limited to such an example. The present embodiment can be applied to various devices that can control the transmission of the image data, for example, an imaging device, a computer such as a personal computer (PC) or a server, and a network switch. Also, the present embodiment can be applied to, for example, a processing integrated circuit (IC) that can be incorporated into the above-described devices.

Also, the reception control apparatus has been described above as the present embodiment, but the present embodiment is not limited to such an example. The present embodiment can be applied to various devices, for example, a storage device that can store various data such as image data, a video switch, a display device, a TV receiver, a tablet device, a communication device such as a mobile phone or a smartphone, a video/audio playback device (or video/audio recording/reproducing device), a game machine, and a computer such as a PC. Also, the present embodiment can be applied to, for example, a processing IC that can be incorporated into the above-described devices.

(Program According to the Present Embodiment)

### [i] Program for Functioning as the Transmission Control Apparatus According to the Present Embodiment

A program for causing a computer to function as the transmission control apparatus according to the present embodiment (for example, program capable of executing the processing related to the transmission control method according to the present embodiment, such as the transmission control processing) is executed by the processor or the like in the computer to thereby realize the communication system that can suppress the band consumption at the time of switching the image to be transmitted.

Also, the program for causing the computer to function as the transmission control apparatus according to the present embodiment is executed by the processor or the like in the computer to thereby achieve the effects exhibited by the above-described processing related to the transmission control method according to the present embodiment.

[ii] Program for Functioning as the Reception Control Apparatus According to the Present Embodiment

A program for causing a computer to function as the reception control apparatus according to the present embodiment (for example, program capable of executing the processing related to the reception control method according to the present embodiment, such as the reception control processing) is executed by the processor in the computer to thereby suppress the band consumption at the time of switching the image to be transmitted.

Also, the program for causing the computer to function as the reception control apparatus according to the present embodiment is executed by the processor or the like in the computer to thereby achieve the effects exhibited by the above-described processing related to the reception control method according to the present embodiment.

The preferred embodiments of the present disclosure have been described in detail with reference to the appended drawings, but the technical scope of the present disclosure is not limited to such examples. It should be understood by those skilled in the art that various modifications, combinations, sub-combinations and alterations may occur depending on design requirements and other factors insofar as they are within the scope of the appended claims or the equivalents thereof.

For example, in the above, the programs (computer programs) for causing the computer to function as each of the transmission control apparatus according to the present embodiment and the reception control apparatus according to the present embodiment are provided, but the present embodiment can also provide a recording medium having each of the programs or both of the programs stored therein.

The above-described configuration indicates an example of the present embodiment and falls within the technical scope of the present disclosure.

Also, the effects described herein are only for illustrative or explanatory purposes, not limiting purposes. That is, it is apparent to those skilled in the art that other effects can be provided from the description of the present disclosure, in addition to or alternative to the above effects.

Additionally, the present technology may also be configured as below.

(1) A transmission control apparatus including:

a transmission control unit configured to transmit image data by changing a stream to transmit the image data from the stream in which the image data is recently transmitted, in each predetermined unit of the image data indicating an image to be transmitted,

wherein, when another device that transmits image data exists, the transmission control unit transmits the image data by changing a stream in synchronization with the other device.

(2) The transmission control apparatus according to (1),

wherein the transmission control unit transmits the image data in two streams.

(3) The transmission control apparatus according to (1) or (2), further including:

a communication unit configured to transmit the image data in a relevant stream in the each predetermined unit.

(4) The transmission control apparatus according to any one of (1) to (3), further including:

an encoding unit configured to encode the image to be transmitted,

wherein the transmission control unit transmits encoded image data.

(5) A reception control apparatus including:

a reception control unit configured to control switching of reception of pieces of image data, which is transmitted from one or more external devices, by synchronously changing a stream to transmit image data in each predetermined unit,

wherein the reception control unit controls the switching of the reception of the image data, in a manner that pre-switching image data, which is received before switching, is not received while overlapping post-switching image data, which is received after switching.

(6) The reception control apparatus according to (5),

wherein, in a case where the reception of the image data is switched, when the reception of the pre-switching image data of the predetermined unit, which is transmitted in one stream, has been completed, the reception control unit stops the reception of the pre-switching image data in the one stream and starts the reception of the post-switching image data in the one stream.

(7) The reception control apparatus according to (5) or (6),

wherein the reception control unit switches the reception of the image data, based on a switching request for requesting the switching of the reception.

(8) The reception control apparatus according to (7), further including:

an operation unit configured to generate the switching request, based on user operation,

wherein the reception control unit switches the reception of the image data based on the generated switching request.

(9) The reception control apparatus according to any one of (5) to (8), further including:

a communication unit configured to receive the image data.

(10) A transmission control method, which is performed by a transmission control apparatus, including:

transmitting image data by changing a stream to transmit the image data from the stream in which the image data is recently transmitted, in each predetermined unit of the image data indicating an image to be transmitted,

wherein, when another device that transmits image data exists in the transmitting step, the image data is transmitted by changing a stream in synchronization with the other device.

(11) A reception control method, which is performed by a reception control apparatus, including:

controlling switching of reception of pieces of image data, which is transmitted from one or more external devices, by synchronously changing a stream to transmit image data in each predetermined unit,

wherein, in the controlling step, the switching of reception of image data is controlled in a manner that pre-switching image data, which is received before switching, is not received while overlapping post-switching image data, which is received after switching.

What is claimed is:

1. A transmission control apparatus comprising:
a transmission control unit configured to transmit image data by changing a stream to transmit the image data from the stream in which the image data is recently transmitted, in each predetermined unit of the image data indicating an image to be transmitted,
wherein, when another device that transmits image data exists, the transmission control unit transmits the image data by changing a stream in synchronization with the other device.

2. The transmission control apparatus according to claim 1,
wherein the transmission control unit transmits the image data in two streams.

3. The transmission control apparatus according to claim 1, further comprising:
a communication unit configured to transmit the image data in a relevant stream in the each predetermined unit.

4. The transmission control apparatus according to claim 1, further comprising:
an encoding unit configured to encode the image to be transmitted,
wherein the transmission control unit transmits encoded image data.

5. A reception control apparatus comprising:
a reception control unit configured to control switching of reception of pieces of image data, which is transmitted from one or more external devices, by synchronously changing a stream to transmit image data in each predetermined unit,
wherein the reception control unit controls the switching of the reception of the image data, in a manner that pre-switching image data, which is received before switching, is not received while overlapping post-switching image data, which is received after switching.

6. The reception control apparatus according to claim 5,
wherein, in a case where the reception of the image data is switched, when the reception of the pre-switching image data of the predetermined unit, which is transmitted in one stream, has been completed, the reception control unit stops the reception of the pre-switching image data in the one stream and starts the reception of the post-switching image data in the one stream.

7. The reception control apparatus according to claim 5,
wherein the reception control unit switches the reception of the image data, based on a switching request for requesting the switching of the reception.

8. The reception control apparatus according to claim 7, further comprising:
an operation unit configured to generate the switching request, based on user operation,
wherein the reception control unit switches the reception of the image data based on the generated switching request.

9. The reception control apparatus according to claim 5, further comprising:
a communication unit configured to receive the image data.

10. A transmission control method, which is performed by a transmission control apparatus, comprising:
transmitting image data by changing a stream to transmit the image data from the stream in which the image data is recently transmitted, in each predetermined unit of the image data indicating an image to be transmitted,
wherein, when another device that transmits image data exists in the transmitting step, the image data is transmitted by changing a stream in synchronization with the other device.

11. A reception control method, which is performed by a reception control apparatus, comprising:
controlling switching of reception of pieces of image data, which is transmitted from one or more external devices, by synchronously changing a stream to transmit image data in each predetermined unit,
wherein, in the controlling step, the switching of reception of image data is controlled in a manner that pre-switching image data, which is received before switching, is not received while overlapping post-switching image data, which is received after switching.
